(19) United States
(12) Patent Application Publication
(10) Pub. No.: US 2022/0358403 A1
(43) Pub. Date: Nov. 10, 2022

(54) COGNITIVE MODE-SETTING IN EMBODIED AGENTS

(71) Applicant: Soul Machines Limited, Auckland (NZ)

(72) Inventors: Mark SAGAR, Auckland (NZ); Alistair KNOTT, Dunedin (NZ); Martin TAKAC, Bratislava (SK); Xiaohang FU, Auckland (NZ)

(21) Appl. No.: 17/621,624

(22) PCT Filed: Jul. 8, 2020
(86) PCT No.: PCT/IB2020/056438

§ 371 Date: Dec. 21, 2021

(30) Foreign Application Priority Data
Jul. 8, 2019 (NZ) 755211

(51) Int. Cl. G06N 20/00; G06T 13/00

(52) U.S. Cl. CPC G06N 20/00; G06T 13/00

(57) ABSTRACT

Embodiments described herein relate to a method of changing the connectivity of a Cognitive Architecture for animating an Embodied Agent, which may be a virtual object, digital entity, and/or robot, by applying Mask Variables to Connectors linking computational Modules. Mask Variables may turn Connectors on or off—or more flexibly, they may module the strength of Connectors. Operations which apply several Mask Variables at once put the Cognitive Architecture in different Cognitive Modes of behaviour.

### TECHNICAL FIELD

Embodiments of the invention relate to the field of artificial intelligence, and more particularly (but not exclusively), to cognitive mode-setting in embodied agents.

### BACKGROUND ART

A goal of artificial intelligence (AI) is to build computer systems with similar capabilities to humans. There is growing evidence that the human cognitive architecture switches between modes of connectivity at different timescales, varying human behaviour, actions and/or tendencies.

Subsumption architectures couple sensory information to “action selection” in an intimate and bottom-up fashion (as opposed to traditional AI technique of guiding behaviour using symbolic mental representations of the world). Behaviours are decomposed into “sub-behaviours” organized in a hierarchy of “layers”, which all receive sensor information, work in parallel and generate outputs. These outputs can be commands to actuators, or signals that suppress or inhibit other “layers”. US20140156577, discloses an artificial intelligence system using an action selection controller that determines which state the system should be in, switching as appropriate in accordance with a current task goal. The action selection controller can gate or limit connectivity between subsystems.

### OBJECTS OF THE INVENTION

It is an object of the present invention to improve cognitive mode-setting in embodied agents or to at least provide the public or industry with a useful choice.

BRIEF DESCRIPTION OF DRAWINGS

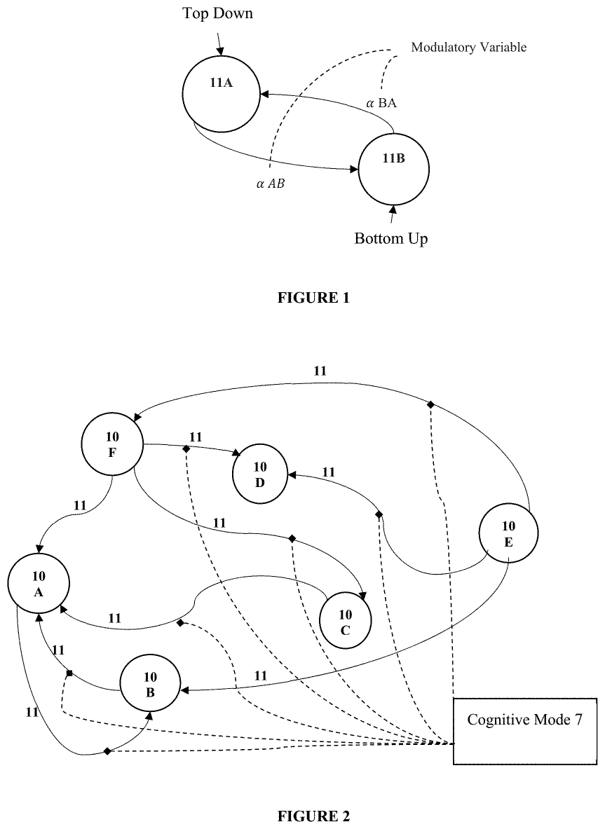

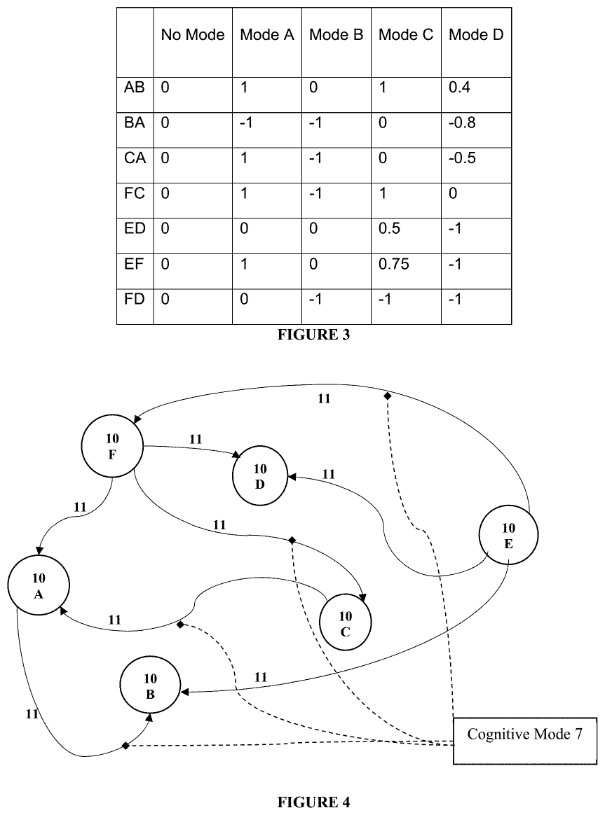

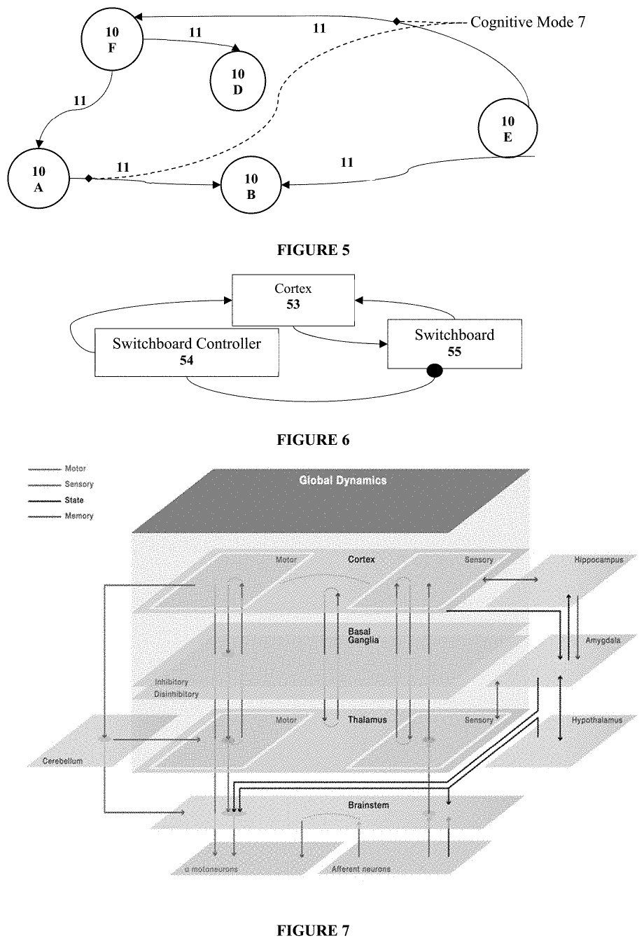

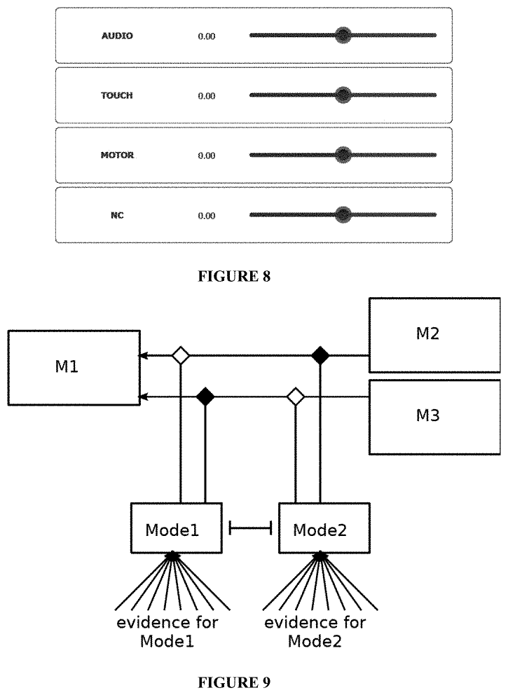

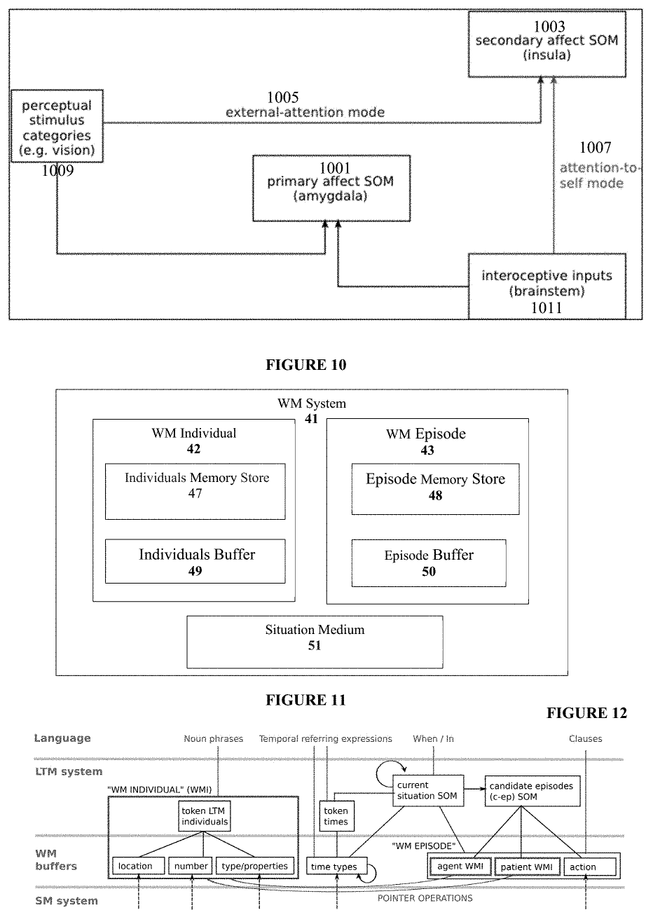

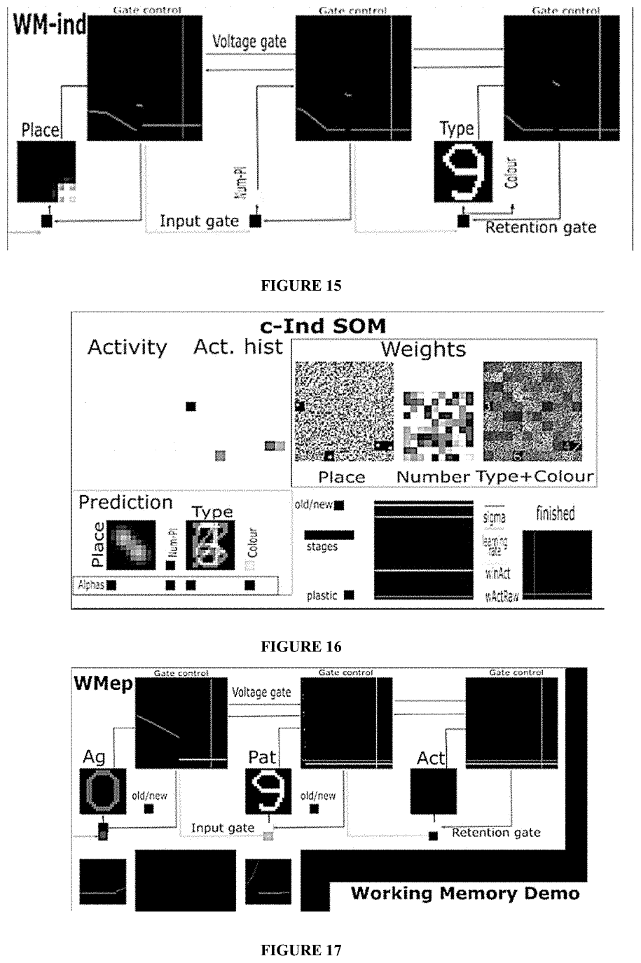

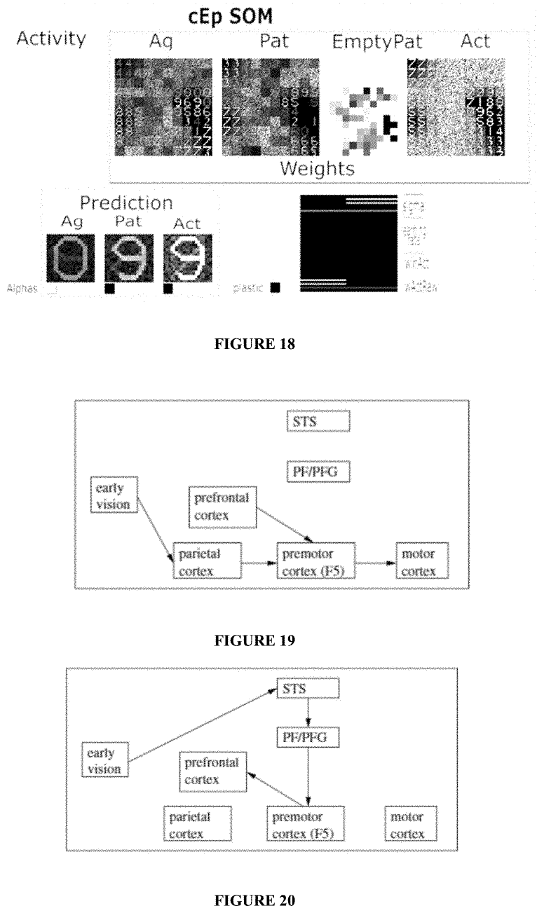

FIG. 1: two Modules and associated
Modulatory Variables;
FIG. 2: interconnected modules associated
with a set of Mask Variables;
FIG. 3: a table of five cognitive modes of
the modules of FIG. 2;
FIG. 4: application of Mode A of FIG. 3;
FIG. 5: application of Mode B of FIG. 3;
FIG. 6: a cortical-subcortical loop;
FIG. 7: a cognitive architecture;
FIG. 8: a user interface for setting
Cognitive Modes;
FIG. 9: three Modules and Connectors;
FIG. 10: connectivity in emotion and action
perception/execution;
FIG. 11: a Working Memory System (WM
System);
FIG. 12: the architecture of a WM System;
FIG. 14: a visualization of an implemented
WM System;
FIG. 15: a screenshot of a visualization of
the Individuals Buffer of FIG. 14;
FIG. 16: a screenshot of a visualization of
the Individuals Memory Store of FIG. 14;
FIG. 17: a screenshot of a visualization of
the Episode Buffer 50 of FIG. 14;
FIG. 18: a screenshot of a visualization of
the Episode Memory Store 48 of FIG. 14;
FIG. 19: Cognitive Architecture
connectivity in “action execution mode”; and
FIG. 20: connectivity in “action perception
mode.

### DETAILED DESCRIPTION

Embodiments described herein relate to a method of changing the connectivity of a Cognitive Architecture for animating an Embodied Agent, which may be a virtual object, digital entity, and/or robot, by applying Mask Variables to Connectors linking computational Modules. Mask Variables may turn Connectors on or off—or more flexibly, they may module the strength of Connectors. Operations which apply several Mask Variables at once put the Cognitive Architecture in different Cognitive Modes of behaviour.

Circuits that perform computation in Cognitive Architectures may run continuously, in parallel, without any central point of control. This may be facilitated by a Programming Environment such as that described in the patent U.S. Ser. No. 10/181,213B2 titled “System for Neurobehavioural Animation”, incorporated by reference herein. A plurality of Modules is arranged in a required structure and each module has at least one Variable and is associated with at least one Connector. The connectors link variables between modules across the structure, and the modules together provide a neurobehavioral model. Each Module is a self-contained black box which can carry out any suitable computation and represent or simulate any suitable element, such as a single neuron, to a network of neurons or a communication system. The inputs and outputs of each Module are exposed as a Module's Variables which can be used to drive behaviour (and in graphically animated Embodied Agents, drive the Embodied Agent's animation parameters). Connectors may represent nerves and communicate Variables between different Modules. The Programming Environment supports control of cognition and behaviour through a set of neurally plausible, distributed mechanisms because no single control script exists to execute a sequence of instructions to modules.

Sequential processes, coordination, and/or changes of behaviour may be achieved using Mode-Setting Operations, as described herein. An advantage of the system is that a complex animated system may be constructed by building a plurality of separate, low level modules and the connections between them provide an autonomously animated virtual object, digital entity or robot. By associating Connectors in a neurobehavioural model with Modulatory Variables and Mask Variables which override Modulatory Variable, the animated virtual object, digital entity or robot may be placed in different modes of activity or behaviour. This may enable efficient and flexible top-town control of an otherwise bottom-up driven system, by higher level functions or external control mechanisms (such as via a user interface), by setting Cognitive Modes.

### Modifying Connectivity Via Cortico-Thalamic-Basal-Ganglia Loop

FIG. 7 shows a high-level architecture of a Cognitive Architecture which may be implemented using a neurobehavioural model according to one embodiment. The Cognitive Architecture shows anatomical and functional structures simulating a nervous system of a virtual object, digital entity, and/or robot. A Cortex 53 has module/s which integrate activity of incoming modules and/or synapse weights modules or association modules with plasticity or changing effects over time. An input to the Cortex 53 comes from an afferent (sensory) neuron. A sensory map may be used to process the data received from any suitable external stimulus such as a camera, microphone, digital input, or any other means. In the case of visual input, the sensory map functions as a translation from the pixels of the stimulus to neurons which may be inputted into the Cortex 53. The Cortex 53 may also be linked to motor neurons, controlling muscle/actuator/effector activation. A brainstem area may contain pattern generators or recurrent neural network modules controlling muscle activations in embodied agents with muscle effectors.

FIG. 6 shows a cortico-thalami-basal ganglia loop which may be modelled to implement cognitive mode setting, which may influence the behaviour and/or actions of the virtual object, digital entity, and/or robot. The Cortex 53 has feedback connections with a Switchboard 55 akin to a thalamus. Feedback loops integrate sensory perception into the Cortex 53. A positive feedback loop may help associate a visual event or stimuli with an action. The Cortex 53 is also connected to a Switchboard Controller 54, akin to a basal ganglia. The Switchboard Controller 54 may provide feedback directly to the Cortex 53 or to the Cortex 53 via the Switchboard 55. The Switchboard Controller 54 modulates the feedback between the Cortex 53 and Switchboard 55. Cortical-Subcortical Loops are modelled using gain control variables regulating connections between Modules which can be set to inhibit, permit, or force communication between Modules representing parts of the Cortex.

### Modulatory Variables

The Switchboard 55 comprises gain control values to route and regulate information depending on the processing state. For example, if an Embodied Agent is reconstructing a memory, then top down connection gains will be stronger than bottom up ones. Modulatory Variables may control the gain of information in the Cognitive Architecture and implement the functionality of the Switchboard 55 in relaying information between Modules representing parts of the Cortex 53.

Modulatory Variables create autonomous behaviour in the Cognitive Architecture. Sensory input triggers bottom-up circuits of communication. Where there is little sensory input, Modulatory Variables may autonomously change to cause top-down behaviour in the Cognitive Architecture such as imagining or day-dreaming. Switchboard 55 switches are implemented using Modulatory Variables associated with Connectors which control the flow of information between Modules connected by the Connectors. Modulatory Variables are set depending on some logical condition. In other words, the system automatically switches Modulatory Variable values based on activity e.g. the state of the world and/or the internal state of the Embodied Agent.

Modulatory Variables may be continuous values between a minimum value and a maximum value (e.g. between 0 and 1) so that information passing is inhibited at the Modulatory Variable's minimum value, allowed in a weighted fashion at intermediate Modulatory Variable values, and full flow of information is forced at the Modulatory Variable's maximum value. Thus, Modulatory Variables can be thought of as a ‘gating’ mechanism. In some embodiments, Modulatory Variables may act as binary switches, wherein a value of 0 inhibits information flow through a Connector, and 1 forces information flow through the Connector.

### Mask Variable

The Switchboard 55 is in turn regulated by the digital Switchboard Controller 54 which can inhibit or select different processing modes. The digital Switchboard Controller 54 activates (forces communication) or inhibits the feedback of different processing loops, functioning as a mask. For example, arm movement can be inhibited if the Embodied Agent is observing rather than acting.

Regulation by the Switchboard Controller 54 is implemented using Mask Variables. Modulatory Variables may be masked, meaning that the Modulatory Variables are overridden or influenced by Mask Variable (which depends on the Cognitive Mode the system is in). Mask Variables may range between a minimum value and a maximum value (e.g. between −1 and 1) such as to override Modulatory Variables when Mask Variables are combined (e.g. summed) with the Modulatory Variables.

The Switchboard Controller 54 forces and Controls the switches of the Switchboard 55 by inhibiting the Switchboard 55, which may force or prevent actions. In certain Cognitive Modes, a set of Mask Variables are set to certain values to change the information flow in the Cognitive Architecture.

### Master Connector Variable

A Connector is associated with a Master Connector Variable, which determines the connectivity of the Connector. Master Connector Variable values are capped between a minimum value, e.g. 0 (no information is conveyed—as if the connector does not exist) and maximum value, e.g. 1 (full information is conveyed).

If a Mask Variable value is set to −1, then regardless of the Modulatory Variable value, the Master Connector Variable value will be 0, and therefore connectivity is turned off. If a Mask Variable value is set to 1, then regardless of the Modulatory Variable value, the Master Connector Variable value will be 1, and connectivity is turned on. If a Mask Variable value is set to 0, then the Modulatory Variable value determines the value of the Master Connector Variable value, and connectivity is according to the Modulatory Variable value.

In one embodiment, Mask Variables are configured to override Modulatory Variables by summation. For example, if a connector is configured to write variables/a to variables/b, then:

Master Connector Variable=Modulatory Variable+Mask Variable>0.?1.:0.

variables/b=Master Connector Variable*variables/a

### Cognitive Modes

The Cognitive Architecture described herein supports operations that change the connectivity between Modules, by turning Connectors between Modules on or off—or more flexibly, by modulating the strength of the Connectors. These operations put the Cognitive Architecture into different Cognitive Modes of connectivity.

In a simple example, FIG. 9 shows three modules, M1, M2 and M3. In a first Cognitive Mode, Mode1, the module M1 receives input from M2. This is achieved by turning the connector C1 on (for example, by setting an associated Mask Variable to 1), and the connector C2 off (for example, by setting an associated Mask Variable to 0). In a second Cognitive Mode, Mode2, the Module M1 receives input from M3. This is achieved by setting the connector C2 on (for example, by setting an associated Mask Variable to 1), and the connector C1 off (for example, by setting a Mask Variable to 0). In the figure, Mask variables of 0 and 1 are denoted by black and white diamonds respectively. Mode1 and Mode2 compete against one another, so that only one mode is selected (or in a continuous formulation, so that one mode tends to be preferred). They do this on the basis of separate evidence accumulators, that gather evidence for each mode.

A Cognitive Mode may include a set of predefined Mask Variables each associated with connectors. FIG. 2 shows six Modules 10, connected with nine Connectors 11 to create a simple neurobehavioural model. Any of the Connectors may be associated with Modulatory Variables. Seven Mask Variables are associated with seven of the Connectors. Different Cognitive Modes 8 can be set by setting different configurations of Mask Variable values (depicted by rhombus symbols).

FIG. 3 shows a table of Cognitive Modes which may be applied to the Modules of FIG. 3. When no Cognitive Mode is set, all Mask Variable values are 0, which allows information to flow through the Connectors 11 according to the default connectivity of the Connectors and/or the Connectors' Modulatory Variable values (if any).

FIG. 4 shows Mode A of FIG. 3 applied to the neurobehavioural model formed by the Modules 10 of FIG. 2. Four of the Connectors 11 (the connectors shown) are set to 1, which forces Variable information to be passed between the Modules connected by the four connectors. The Connector from Module B to Module A is set to −1, preventing Variable information to be passed from Module B to Module A, having the same functional effect as removing the Connector.

FIG. 5 shows Mode B of FIG. 3 applied to the neurobehavioural model formed by the Modules 10 of FIG. 2. Four of the Connectors 11 are set to −1, preventing Variable information to be passed along those connections, functionally removing those Connectors. Module C is effectively removed from the network as no information is able to pass to Module C or received from Module C. A path of information flow remains from F→G→A→B.

Cognitive modes thus provide arbitrary degrees of freedom in Cognitive Architectures and can act as masks on bottom-up/top-down activity.

Different Cognitive Modes may affect the behaviour of the Cognitive Architectures by modifying the:
Inputs received by modules
Connectivity between different Modules (which Modules are connected to each other in the neurobehavioural model)
Flow of control in control cycles (which paths variables take to flow between Modules)
Strength of connections between different Modules (the degree to which variables propagate to connected modules.)

Or any other aspects of the neurobehavioural model. Mask Variables can be context-dependent, learned, externally Imposed (e.g. manually set by a human user), or set according to intrinsic dynamics. A Cognitive Mode may be an executive control map (e.g. a typologically connected set of neurons or detectors, which may be represented as an array of Neurons) of the neurobehavioural model.

Cognitive Modes may be learned. Given a sensory context, and a motor action, reinforcement-based learning may be used to learn Mask Variable values to increase reward and reduce punishment.

Cognitive Modes may be set in a Constant Module, which may represent the Basal Ganglia. The values of Constant Variables may be read from or written to by Connectors and/or by user interfaces/displays. The Constant Module provides a useful structure for tuning a large number of parameters, as multiple parameters relating to disparate Modules can be collated in a single Constant Module. The Constant Module contains a set of named variables which remain constant in the absence of external influence (hence “constant”—as the module does not contain any time stepping routine).

For example, a single constant module may contain 10 parameter values linked to the relevant variables in other modules. Modifications to any of these parameters using a general interface may now be made via a parameter editor for a single Constant Module, rather than requiring the user to select each affected module in turn.

In some embodiments, Cognitive Modes may directly set Variables, such as neurochemicals, plasticity variables, or other variables which change the state of the neurobehavioural model.

Multiple Cognitive Modes at once

Multiple cognitive modes can be active at the same time. The overall amount of influence of a Mask Variable is the sum of the a Mask Variable from all active Cognitive Modes. Sums may be capped to a minimum value and maximum value as per the Master Connector Variable minimum and maximum connectivity. Thus strongly positive/negative values from a Cognitive Mode may overrule corresponding values from another Cognitive Mode.

### Degrees of Modes

The setting of a Cognitive Mode may be weighted. The final values of the Mask Variables corresponding to a partially weighted Cognitive Mode are multiplied by the weighting of the Cognitive Mode.

For example, if a “vigilant” Cognitive Mode defines the Mask Variables [−1, 0, 0.5, 0.8], the degree of vigilance may be set such that the agent is “100% vigilant” (in full vigilance mode): [−1, 0, 0.5, 0.8], 80% vigilant (somewhat vigilant) [−0.8, 0, 0.4, 0.64], or 0% vigilant (vigilant mode is turned off) [0,0,0,0].

### Further Layers of Control

Further layers of control over Cognitive Modes may be added using Additional-Mask Variables, using the same principles described herein. For example, Mask Variables may be defined to set internally-triggered Cognitive Modes (i.e. Cognitive Modes triggered by processes within the neurobehavioural model), and Additional Mask Variables may be defined to set externally-triggered Cognitive Modes, such as by a human interacting with the Embodied Agent via a user interface, or verbal commands, or via some other external mechanism. The range of the Additional Mask Variables may be greater than that of the first-level Mask Variables, such that Additional Mask Variables override first-level Mask Variables. For example, given Modulatory Variable between [0 to 1], and Mask Variables between [−1 to +1], the Additional Mask Variables may range between [−2 to +2].

### Triggering Cognitive Modes

A Mode-Setting Operation is any cognitive operation that establishes a Cognitive Mode. Any element of the neurobehavioural model defining the Cognitive Architecture can be configured to set a Cognitive Mode. Cognitive Modes may be set in any conditional statements in a neurobehavioural model, and influence connectivity, alpha gains and flow of control in control cycles. Cognitive Modes may be set/triggered in any suitable manner, including, but not limited to:
Event-driven cognitive mode setting
Manual Setting through a user interface
A cascade of Mode-Setting Operations
Timer-based cognitive mode setting

In one embodiment, sensory input may automatically trigger the application of one or more cognitive modes. For example, a low-level event such as a loud sound, sets a vigilant Cognitive Mode.

A user interface may be provided to allow a user to set the Cognitive Modes of the agent. There may be hard-wired commands that cause the Agent to go into a particular mode. For example, the phrase “go to sleep” may place the Agent in a Sleep Mode.

Verbs in natural language can denote Mode-Setting Operations as well as physical motor actions and attentional/perceptual motor actions. For instance:
‘to remember’ can denote entering memory retrieval mode;
‘to make’ can denote the activation of a mode connecting representations of objects with associated motor plans that create these objects, so that a representation of a goal object can trigger the plan that creates it.

The Embodied Agent can learn a link cognitive plans with symbols of object concepts (for example, the name of a plan). For example, the Embodied Agent may learn a link between the object concept ‘heart’ in a medium holding goals or plans, and a sequential motor plan that executes the sequence of drawing movements that creates a triangle. The verb ‘make’ can denote the action of turning on this link (through setting the relevant Cognitive Mode), so that the plan associated with the currently active goal object is executed.

Certain processes may implement time-based Mode-Setting Operations. For example, in a mode where an agent is looking for an item, a time-limit may be set, after which the agent automatically switches to a neutral mode, if the item is not found.

### Types of Cognitive Modes

### Attentional Modes

Attentional Modes are Cognitive Modes control which may control which sensory inputs or other streams of information (such as its own internal state) the Agent attends to. FIG. 8 shows a user interface for setting a plurality of Mask Variable values corresponding to input channels for receiving sensory input. For example, in a Visual Vigilance Cognitive Mode, the Visual Modality is always eligible. Bottom-up visual input channels are set to 1. Top-down activation onto visual is blocked by setting top-down Mask Variables to −1. In a Audio Vigilance Cognitive Mode, Audio is always eligible. Bottom-up audio input channels are set to 1. Top-down activation onto audio is blocked by setting top-down Mask Variables to −1. In a Touch Vigilance Cognitive Mode, Touch is always eligible. Bottom-up audio input channels are set to 1. Top-down activations onto touch are blocked by setting Mask Variables to −1.

### Switching Between Action Execution and Perception

Two Cognitive Modes ‘action execution mode’ and ‘action perception mode’ may deploy the same set of Modules with different connectivity. In ‘action execution mode’, the agent carries out an Episode, whereas in an ‘action perception mode’, the agent passively watches an Episode. In both cases, the Embodied Agent attends to an object being acted on and activates a motor program.

FIG. 19 shows Cognitive Architecture connectivity in “action execution mode”. In action execution, the distribution over motor programmes in the agent's premotor cortex is activated through action affordances computed—and the selected motor program is conveyed to primary motor cortex, to produce actual motor movements. Information flows from a medium encoding a repertoire of possible actions outwards to the agent's motor system. FIG. 20 shows connectivity in “action perception mode”. In action perception, there is no connection to primary motor cortex (otherwise the agent would mimic the observed action). Premotor representations activated during action recognition are used to infer the likely plans and goals of the observed WM agent. Information flows from the agent's perceptual system into the medium encoding a repertoire of possible actions.

When the Embodied Agent is operating in the world, the agent may decide whether to perceive an external event, involving other people or objects, or perform an action herself. This decision is implemented as a choice between ‘action perception mode’ and ‘action execution mode’. ‘Action execution mode’ and ‘action perception mode’ endure over complete Episode apprehension processes.

### Mirror System of Emotions

A primary emotions associative memory 1001 may learn correlations between perceived and experienced emotions as shown in FIG. 10, and receive input corresponding to any suitable perceptual stimulus (e.g. vision) 1009 as well as intereroceptive inputs 1011. Such associative memory may be implemented using a Self-Organizing Map (SOM) or any other suitable mechanism. After training on correlations, the primary emotions associative memory may be activated equally by an emotion when it is experienced as when it is perceived. Thus, the perceived emotion can activate the experienced emotion in the interoceptive system (simulating empathy).

A secondary emotions SOM 1003 learns distinction the agent's own emotions and those perceived in others. The secondary emotions associative memory may implement three different Cognitive Modes. In an initial “Training Mode”, the secondary emotions associative memory learns exactly like the primary emotions associative memory, and acquires correlations between experienced and perceived emotions. After learning correlations between experienced and perceived emotions, the secondary emotions SOM may automatically switch to two other modes (which may be triggered in any suitable manner, for example, exceeding a threshold of the number or proportion of trained neurons in the SOM). In an “Attention to Self” mode 1007 activity is passed into the associative memory exclusively from interoceptive states 1011.

In this mode, the associative memory represents only the affective states of the agent. In an “External Attention” Mode 1005 activity is passed into the associative memory exclusively from the perceptual system 1009. In this mode, the associative memory represents only the affective states of an observed external agent. Patterns in this associative memory encode emotions without reference to their ‘owners’, just like the primary emotions associative memory. The mode of connectivity currently in force signals whether the represented emotion is experienced or perceived.

### Language Modes

The Cognitive Architecture may be associated with a Language system and Meaning System (which may be implemented using a WM System as described herein). The connectivity of the Language system and Meaning System can be set in different Language Modes to achieve different functions. Two inputs (Input_Meaning, Input_Language) may be mapped to two outputs (Output_Meaning, Output_Language), by opening/closing different Connectors: In a “Speak Mode”, Naming/Language production is achieved by turning “on” the Connector from Input_meaning to Output_language. In a “Command obey mode” language interpretation is achieved by turning “on” the Connector from Input_language to Output_meaning. In a “language learning” mode, inputs into Input_language and Input_meaning are allowed, and the plasticity of memory structures configured to learn language and meaning is increased to facilitate learning.

### Cognitive Modes for Emotional Mode

Emotional states may be implemented in the Cognitive Architecture as Cognitive Modes (Emotional Modes), influencing the connectivity between Cognitive Architecture regions, in which different regions interact productively to produce a distinctive emergent effect. Continuous ‘emotional modes’ are modelled by continuous Modulatory Variables on connections linking into a representation of the Embodied Agent's emotional state. The Modulatory Variables may be associated with Mask Variables to set emotional modes in a top-down manner.

### Attending to Emotional State

The mechanism that attribute an emotion to the self or to another person, and that indicates whether the emotion is real or imagined, involves the activation of Cognitive Modes of Cognitive Architecture connectivity. The mode of connectivity currently in force signals whether the represented emotion is experienced or perceived. Functional connectivity can also be involved in representing the content of emotions, as well as in representing their attributions to individuals. There may be are discrete Cognitive Modes associated with the basic emotions. The Cognitive Architecture can exist in a large continuous space of possible emotional modes, in which several basic emotions can be active in parallel, to different degrees. This may be reflected in a wide range of emotional behaviours, including subtle blends of dynamically changing facial expressions, mirroring the nature of the continuous space.

The agent's emotional system competes for the agent's attention, alongside other more conventional attentional systems—for instance the visuospatial attentional system. The agent may attend to its own emotional state as an objects of interest in its own right, using a Mode-Setting Operation. In a “internal emotion mode”, the agent's attentional system is directed towards the agent's own emotional state. This mode is entered by consulting a signal that aggregates over all the emotions the agent is experiencing.

In an emotion processing mode, the agent may enter a lower-level attentional mode, to select a particular emotion from possible emotions to focus its attention on. When one of these emotions is selected, the agent is ‘attending’ to a particular emotion (such as attending to joy, sadness or anger).

### Cognitive Modes for Planning/Sequencing

A method of sequencing and planning, using a “CBLOCK” is described in the provisional patent application NZ752901, titled “SYSTEM FOR SEQUENCING AND PLANNING” also owned by the present applicant, and incorporated by reference herein. Cognitive Modes as described herein may be applied to enable the CBLOCK to operate different modes. In a “Learning Mode”, the CBLOCK passively receives a sequence of items, and learns chunks encoding frequently occurring sub sequences within this sequence. During learning, the CBLOCK observes an incoming sequence of elements, at the same time predicting the next element. While the CBLOCK can correctly predict the next element, an evolving representation of a chunk is created. When the prediction is wrong (‘surprise’), the chunk is finished, its representation is learned by another network (called a “tonic SOM”), then reset and the process starts over. In a “Generation Mode”, the CBLOCK actively produces sequences of items, with a degree of stochasticity, and learns chunks that result in goal states, or desired outcome states. During generation, the predicted next element becomes the actual one in the next step, so instead of “mismatch”, the entropy of the predicted distribution is used: the CBLOCK continues generation while the entropy is low and stops when it exceeds a threshold.

In a “Goal-Driven Mode” (which is a subtype of generation mode), the CBLOCK begins with an active goal, then selects a plan that is expected to achieve this goal, then a sequence of actions that implement this plan. In a “Goal-Free” mode, the CBLOCK passively receives a sequence of items, and makes inferences about the likely plan (and goal) that produced this sequence, that are updated after each new item.

### Cognitive Modes for Learning

Cognitive Modes may control what, and to what extent the Embodied Agent learns. Modes can be set to make learning and/or reconstruction of memories contingent on any arbitrary external conditions. For instance, associative learning between a word and a visual object representation can be made contingent on the agent and the speaker jointly attending to the object in question. Learning may be blocked altogether by turning off all connections to memory storage structures.

A method of learning using Self-Organizing Maps (SOMS) as memory storage structures is described in the provisional patent application NZ755210, titled “MEMORY IN EMBODIED AGENTS” also owned by the present applicant, and incorporated by reference herein. Accordingly, the Cognitive Architecture is configured to associate 6 different types (modalities) of inputs: Visual—28×28 RGB fovea image Audio, Touch—10×10 bitmap of letters A-Z (symbolic of touch), Motor—10×10 bitmap of upsampled 1-hot vector of length 10, NC (neurochemical)—10×10 bitmap of upsampled 1-hot vector of length 10, Location (foveal)—10×10 map of x and y coordinates. Each type of input may be learned by individual SOMs. SOMs may be activated top-down or bottom-up, in different Cognitive Modes. In an “Experience Mode”, a SOM which represents a previously-remembered Events may be ultimately presented with a fully-specified new event that it should encode. While the agent is in the process of experiencing this event, this same SOM is used in a “Query Mode” where it is presented with the parts of the event experienced so far, and asked to predict the remaining parts, so these predictions can serve as a top-down guide to sensorimotor processes.

Associations may be learned through Attentional SOMs (ASOMs), which take activation maps from low-level SOMs and learns to associate concurrent activations, e.g. VAT (visual/audio/touch) and VM (visual/motor). The Connectors between the first-order (single-modality) SOMS to the ASOMS may be associated with Mask Variables to control learning in the ASOMs.

ASOMs as described in support arbitrary patterns of inputs and outputs, which allow ASOMS to be configured to implement different Cognitive Modes, which can be directly set by setting ASOM Alpha Weights corresponding to Input Fields.

In different Cognitive Modes, ASOM Alpha Weights may be set in different configurations to:
reflect the importance of different layers.
ignore modalities for specific tasks.
dynamically assign attention/focus to different parts of the input, including shutting off parts of input and predicting input values top-down. A ASOM Alpha Weight of 0 acts as wildcard, because that part of input can be anything and it will not influence the similarity judgment delivered by the Weighted Distance Function.

### WM System for Episode Processing Using Deictic Routines

The Cognitive Architecture may process Episodes experienced by the Embodied Agent denoting happenings in the world. Episodes are represented as sentence-sized semantic units centred around an action (verb) and the action's participants. Different objects play different “semantic roles” or “thematic roles” in Episodes. A WM Agent is the cause or initiator of an action and a WM Patient is the target or undergoer of an action. Episodes may involve the Embodied Agent acting, perceiving actions done by other agents, planning or imagining events or remembering past events.

Representations of Episodes may be stored and processed in a Working Memory System (WM System), which processes Episodes using Deictic Routines: prepared sequences with regularities encoded as discrete Deictic Operations. Deictic Operations may include: sensory operations, attentional operations, motor operations, cognitive operations, Mode-Setting Operations.

Prepared Deictic Routines comprising Deictic Operations support a transition from the continuous, real-time, parallel character of low-level perceptual and motor processing, to discrete, symbolic, higher-level cognitive processing. Thus, the WM System 41 connects low-level object/Episode perception with memory, (high-level) behaviour control and language that can be used to report Deictic Routines and/or Episodes. Associating Deictic Representations and Deictic Routines with linguistic symbols such as words and sentences, allows agents to describe what they experience or do, and hence compress the multidimensional streams of neural data concerning the perceptual system and muscle movements.

“Deictic” denotes the idea that the meaning of something is dependent on the context in which it is used. For example, in the sentence “have you lived here long?”, the word “you”, deictically refers to person being spoken to, and the word “here” refers to the place in which the dialogue participants are situated. As described herein, “Deictic” operations, representations and routines are centred around the Embodied Agent.

### Deictic Mode Setting Operations

Regarding the Modules shown in FIG. 9, in Mode 1, M1 receives its input from module M2. In Mode 2, M1 receives its input from Mode 3. The representations computed by M1 are deictically referred to′ the module currently providing M1 with input. An operation that sets the current mode establishes this deictic reference and can therefore be considered a Deictic Operation.

Deictic Operations can combine external sensorimotor operations with Mode-Setting Operations. For instance, a single Deictic Operation could orient the agent's external attention towards a certain individual in the world, and put the agent's Cognitive Architecture into a given mode. Mode-Setting Operations can feature by themselves in deictic routines. For instance, a deictic routine could involve first the execution of an external action of attention to an object in the world, and then, the execution of a Mode-Setting Operation.

Examples of Deictic Operations which are Mode-Setting Operations include: Initial mode, Internal mode, External mode, Action perception mode, Action execution mode, Intransitive action monitoring mode, Transitive action monitoring mode.

### Memory of Episodes/Cascade of Mode-Setting Operations

Object representations in an Episode are bound to roles (such as WM Agent and WM Patient) using place coding. The Episode Buffer includes several fields, and each field is associated with a different semantic/thematic role. Each field does not hold an object representation in its own right, but rather holds a pointer to Long Term Memory storage which represents objects or Episodes. Event representations represent participants using pointers into the medium representing individuals. There are separate pointers for agent and patient. The pointers are active simultaneously in a WM event representation, but they are only followed sequentially, when an event is rehearsed. Episodes are high level sequential sensorimotor routines, some of whose elements may have sub-sequences. Prepared sensorimotor sequences are executable structures that can sequentially initiate structured sensorimotor activity. Prepared sequence of SM operations contains sub-assemblies representing each individual operation. These sub-assemblies are active in parallel in the structure representing a planned sequence, even though they represent operations that are active one at a time.

In a scene with multiple (potentially moving) objects, the Agent first fixates a salient object and puts it in the WM Agent role, then it fixates another object in the WM Patient role (unless the episode is intransitive—in that case an intransitive WM Action would be recognized and a patient would have a special flag ‘empty’) and then it observes the WM Action.

Object representations are bound to roles (such as WM Agent and WM Patient) using place coding. The Episode Buffer includes several fields, and each field is associated with a different semantic/thematic role. Each field does not hold an object representation in its own right, but rather holds a pointer to LTM storage which represents objects or episodes. Event representations represent participants using pointers into the medium representing individuals—and that there are separate pointers for agent and patient. The pointers are active simultaneously in a WM event representation, but they are only followed sequentially, when an event is rehearsed.

FIG. 12 shows the architecture of a WM System 41. The prepared sensorimotor sequence associated with an individual is stored as a sustained pattern of activity in Individuals Buffer 49 holding location, number and type/properties. Episode representations make reference to individuals in an Episode Buffer 50 which has separate fields for each role: the WM Agent and WM Patient fields of a WM Episode each holding pointers back to the memory media representing the respective individuals.

FIG. 11 shows a Working Memory System (WM System) 41, configured to process and store Episodes. The WM System 41 includes a WM Episode 43 and WM Individual 42. The WM Individual 42 defines Individuals which feature in Episodes. WM Episode 43 includes all elements comprising the Episode including the WM Individual/s and the actions. In a simple example of a WM Episode 43, including the individuals WM Agent, and WM Patient: the WM Agent, WM Patient and WM Action are processed sequentially to fill the WM Episode.

An Individuals Memory Store 47 stores WM Individuals. The Individuals Memory Store may be used to determine whether an individual is a novel or reattended individual. The Individuals Memory Store may be implemented as a SOM or an ASOM wherein novel individuals are stored in the weights of newly recruited neurons, and reattended individuals update the neuron representing the reattended individual. Representations in semantic WM exploit the sequential structure of perceptual processes. The notions of agent and patient are defined by the serial order of attentional operations in this SM sequence. FIG. 16 shows a screenshot of a visualization of the Individuals Memory Store of FIG. 14.

A Episode Memory Store 48 stores WM Episodes and learns localist representations of Episode types. The Episode Memory Store may be implemented as a SOM or an ASOM that is trained on combinations of individuals and actions. The Episode Memory Store 48 may include a mechanism for predicting possible Episode constituents. FIG. 18 shows a screenshot of a visualization of the Episode Memory Store 48 of FIG. 14. The Episode Memory Store 48 may be implemented as an ASOM with three Input Fields—agent, patient and action that take input from the respective WM Episode slots.

An Individuals Buffer 49 sequentially obtains attributes of an Individual. Perception of an individual involves a lower-level sensorimotor routine comprising three operations:
1. selection of a salient region of space
2. selection of a classification scale (determining whether a singular or plural stimulus will be classified). The attentional system may be configured to represent groups of objects of the same type as a single individual and/or a single salient region.
3. activation of an object category.

The flow of information from perceptual media processing the scene into the Individuals Buffer may be controlled by a suitable mechanism—such as a cascading mechanism as described under “Cascading State Machine”. FIG. 15 shows a screenshot of a visualization of the Individuals Buffer of FIG. 14. The Individuals Buffer consists of several buffers, for location, number, and rich property complex represented by a digit bitmap and a colour.

An Episode Buffer sequentially obtains elements of an Episode. The flow of information from into the Episode Buffer may be controlled by a suitable mechanism—such as a cascading mechanism as described under “Cascading State Machine”. FIG. 17 shows a screenshot of a visualization of the Episode Buffer 50 of FIG. 14. Perception of an Episode goes through sequential stages of agent, patient and action processing, the result of each of which is stored in one of the three buffers of the Episode Buffer 50.

A recurrent Situation Medium (which may be a SOM or a CBLOCK, as described in Patent NZ752901) tracks sequences of Episodes. ‘predicted next Episode’ delivers a distribution of possible Episodes that can serve as a top-down bias on Episode Memory Store 48 activity and predict possible next Episodes and their participants.

In the scene, many of the objects may be moving and therefore their locations are changing. A mechanism is provided for tracking multiple objects such that a plurality of objects can be attended to and monitored simultaneously in some detail. Multiple trackers may be included, one for each object, and each of the objects are identified and tracked one by one.

### Cascading State Machine

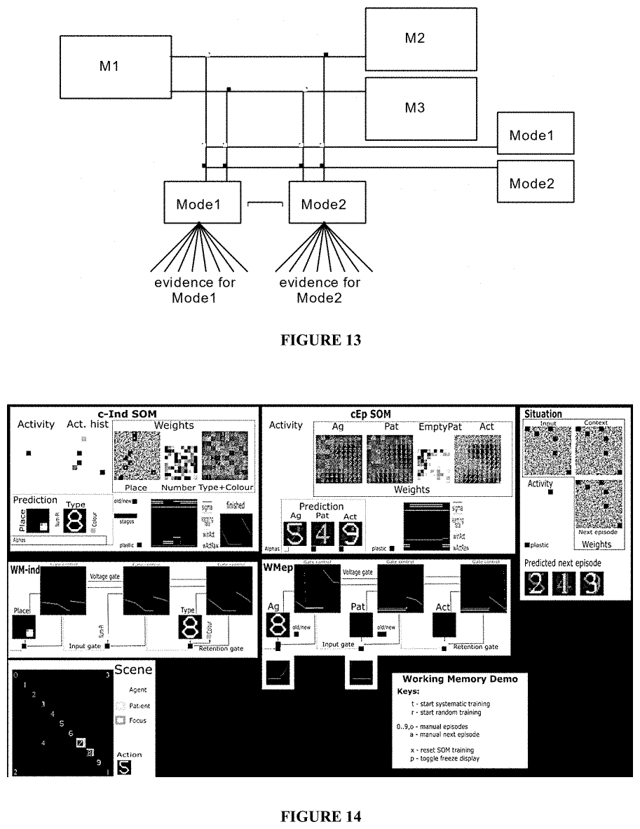

Deictic Routines may be implemented using any suitable computational mechanism for cascading. In one embodiment, a cascading state machine is used, wherein Deictic Operations are represented as states in the cascading state machine. Deictic Routines may involve a sequential cascade of Mode-Setting Operations, in which each Cognitive Mode constrains the options available for the next Cognitive Mode. This scheme implements a distributed, neurally plausible form of sequential control over cognitive processing. Each Mode-Setting Operation establishes a Cognitive Mode—and in that Cognitive Mode, the mechanism for deciding about the next Cognitive Mode is activated. The basic mechanism allowing cascading modes is to allow the gating operations that implement modes to themselves be gatable by other modes. This is illustrated in FIG. 13. For instance, the agent could first decide to go into a Cognitive Mode where salient/relevant events are retrieved from memory. After having retrieved some candidate events, the agent could go into a Cognitive Mode for attending ‘in memory’ to a WM Individual, highlighting events featuring this individual. After this, the agent could decide between a Cognitive Mode to register a state of the WM Individual, or an action performed by the WM Individual.

### Interpretation

The methods and systems described may be utilised on any suitable electronic computing system. According to the embodiments described below, an electronic computing system utilises the methodology of the invention using various modules and engines. The electronic computing system may include at least one processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the electronic computing system may include one or more communication devices (wired or wireless) for communicating with external and internal devices, and one or more input/output devices, such as a display, pointing device, keyboard or printing device. The processor is arranged to perform the steps of a program stored as program instructions within the memory device. The program instructions enable the various methods of performing the invention as described herein to be performed. The program instructions, may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium. The electronic computing system is arranged to be in communication with data storage systems or devices (for example, external data storage systems or devices) in order to retrieve the relevant data. It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines. The arrangement and construction of the modules or engines may be adapted accordingly depending on system and user requirements so that various functions may be performed by different modules or engines to those described herein, and that certain modules or engines may be combined into single modules or engines. The modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using, any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device. The methods described herein may be implemented using a general-purpose computing system specifically programmed to perform the described steps. Alternatively, the methods described herein may be implemented using a specific electronic computer system such as a data sorting and visualisation computer, a database query computer, a graphical analysis computer, a data analysis computer, a manufacturing data analysis computer, a business intelligence computer, an artificial intelligence computer system etc., where the computer has been specifically adapted to perform the described steps on specific data captured from an environment associated with a particular field.

### SUMMARY

In one embodiment: a computer implemented system for animating a virtual object, digital entity or robot, the system including: a plurality of Modules, each Module being associated with at least one Connector, wherein the Connectors enable flow of information between Modules, and the Modules together provide a neurobehavioural model for animating the virtual object, digital entity or robot, wherein two or more of the Connectors are associated with: Modulatory Variables configured to modulate the flow of information between connected Modules; and Mask Variables configured to override Modulatory Variables.

In another embodiment, there is provided: A computer implemented method of for processing an Episode in an Embodied Agent using a Deictic Routine, including the steps of: defining a prepared sequence of fields corresponding to elements of the Episode; defining a prepared sequence of Deictic Operations using a state machine, wherein: each state of the state machine is configured to trigger one or more Deictic Operations; and at least two states of the state machine are configured to complete fields of the Episode, wherein the set of Deictic Operations include: at least one Mode-Setting Operation; at least one Attentional Operation; and at least one Motor Operation.

1. A computer implemented system for animating a virtual object, digital entity or robot, the system including:
a plurality of Modules, each Module being associated with at least one Connector, wherein the Connectors enable flow of information between Modules, and the Modules together provide a neurobehavioural model for animating the virtual object, digital entity or robot,
wherein two or more of the Connectors are associated with:
Modulatory Variables configured to modulate the flow of information between connected Modules; and
Mask Variables configured to override Modulatory Variables.

2. The system of claim 1 further including a Cognitive Modes comprising predefined sets of Mask Variable values configured to set the connectivity of the Neurobehavioural Mode1.

3. The system of claim 1 wherein the Modulatory Variables are continuous variables having a range, wherein the minimum value of the variable inhibits connectivity and the maximum value forces connectivity.

4. The system of claim 1 wherein the two or more Connectors are associated with a Master Connector Variable capped between a minimum value and a maximum value, and wherein the Master Connector Variable is a function of an associated Modulatory Variable and an associated Mask Variable.

5. The system of claim 4 wherein the function sums the associated Modulatory Variables and the associated Mask Variable.

6. The system of claim 1 wherein Modulatory Variables store dynamically set values, set according to a logical condition.

7. The system of claim 6 wherein dynamically set values are associated with Variables in the neurobehavioural model.

8. The system of claim 1 wherein the Mask Variable are continuous variables having a range, wherein a minimum value of the Mask Variable inhibits connectivity of its associated Connector regardless of the associated Modulatory Variables value and the maximum value of the Mask Variable forces connectivity of its associated Connector regardless of the associated Modulatory Variables value.

9. The system of claim 1 wherein Cognitive Modes include one or more of the group comprising: Attentional Modes, Emotional Modes, Language Modes, Behavioural Modes and Learning Modes.

10. The system of claim 1 wherein at least one of the Modules or Connectors includes is configured to set a Cognitive Mode according to a logical condition.

11. The system of claim 1 wherein the system supports setting Cognitive Modes in a weighted fashion, wherein each of the Mask Variables of the Cognitive Mode are weighted proportionally to the weighting of the Cognitive Mode.

12. The system of claim 1 wherein the system supports setting multiple Cognitive Modes, wherein Mask Variables common to the multiple Cognitive Modes are combined.

13. A computer implemented method of for processing an Episode in an Embodied Agent using a Deictic Routine, including the steps of:
defining a prepared sequence of fields corresponding to elements of the Episode;
defining a prepared sequence of Deictic Operations using a state machine, wherein:
each state of the state machine is configured to trigger one or more Deictic Operations; and
at least two states of the state machine are configured to complete fields of the Episode,
wherein the set of Deictic Operations include:
at least one Mode-Setting Operation;
at least one Attentional Operation; and
at least one Motor Operation.

14. The method of claim 13 wherein at least one Mode-Setting Operation available as a Deictic Operation is determined by a preceding Cognitive Mode-Setting Operation triggered in the Deictic Routine.
